(19) United States
(12) Patent Application Publication
(10) Pub. No.: US 2007/0248167 A1
(43) Pub. Date: Oct. 25, 2007

(54) IMAGE STABILIZER, SYSTEM HAVING THE SAME AND METHOD OF STABILIZING AN IMAGE

(76) Inventors: Jun-Hyun Park, Seoul (KR); Ming Zhao, Yongin-si (KR)

Correspondence Address: F. CHAU & ASSOCIATES, LLC, 130 WOODBURY ROAD, WOODBURY, NY, 11797, US

(21) Appl. No.: 11/678,929

(22) Filed: Feb. 26, 2007

(30) Foreign Application Priority Data
Feb. 27, 2006 (KR) 2006-18572

(51) Int. Cl. H04N 7/12

(52) U.S. Cl. 375/240.16; 375/E07.104

(57) ABSTRACT

An image stabilizer includes a motion estimation unit, a motion vector selection unit, a motion compensation vector calculation unit and an image compensation unit. A plurality of divided areas of a picture is projected onto a plurality of windows. The motion estimation unit extracts motion vectors from the plurality of windows. The motion vector selection unit selects an optimal motion vector among the plurality of motion vectors. The motion compensation vector calculation unit calculates a motion compensation vector using the optimal motion vector. The image compensation unit compensates an image of the picture using the motion compensation vector. Accordingly a sudden shift effect may be reduced when stabilizing the image.

### CROSS-REFERENCE TO RELATED APPLICATIONS

This application claims priority under 35 USC §119 to Korean Patent Application No. 2006-18572, filed on Feb. 27, 2006 in the Korean Intellectual Property Office (KIPO), the disclosure of which is incorporated herein in its entirety by reference.

### BACKGROUND OF THE INVENTION

1. Technical Field

The present disclosure relates to an image stabilizer and, more particularly, to an image stabilizer capable of preventing a sudden shift effect, a system including the image stabilizer, and a method of stabilizing an image.

2. Discussion of Related Art

Image recording/playing devices, such as digital video cameras (DVCs), digital still cameras (DSCs), and video cassette recordeers (VCRs), have various functions, and users can take various images of objects using the various functions. When users take an image of an object using such small-sized and portable devices, such as a DVC or a DSC, camera shake may adversely influence the picture. Therefore, various techniques are used to detect and compensate for motion of the camera caused by camera shake, in order to ensure image stability.

Image stabilizers are classified into three types: an Electronic Image Stabilizer (EIS), an Optical Image Stabilizer (OIS) and a Digital Image Stabilizer (DIS), according to the different methods of compensation that are employed.

A DIS uses an image signal directly, instead of using an additional motion detection sensor for stabilizing the image, and it may be easily integrated into a chip. The DIS, however, has to be capable of distinguishing the motion of an object in a picture from the motion of the entire picture caused by camera shake. Moreover, the DIS has to be capable of recognizing a user's intentional motion, such as panning.

FIG. 1 is a block diagram illustrating a conventional camera device.

Referring to FIG. 1, the conventional camera device includes an image sensor 10, an analog signal processor (ASP) 11, an analog-to-digital converter (ADC) 12, a digital signal processor (DSP) 13, a field memory 14 and a motion estimation/compensation unit 15. The image sensor 10 receives an optical scene and outputs an electrical signal converted from the optical scene. The ASP 11 processes (amplifies) an analog signal, that is, the electrical signal outputted from the image sensor 10. The ADC 12 converts the processed signal from the image sensor 10 to a digital signal. The DSP 13 receives the digital image signal, performs image and gamma correction, and converts the digital image signal into YCbCr format, for example.

The field memory 14 stores the image data outputted from the DSP 13, and outputs image data in which motion has been compensated for by the motion estimation/compensation unit 15.

The motion estimation/compensation unit 15 may include a motion estimation unit 150 for detecting camera shake using the image data provided by the DSP 13 and a motion compensation unit 151 for generating a control signal for adjusting an address of the stored data in the field memory 14.

The control signal outputted from the motion compensation unit 151 is provided to the field memory 14, thereby compensating for motion of the image. The field memory 14 then outputs the motion-compensated image data.

The motion estimation/compensation unit 15 including the motion estimation unit 150 and the motion compensation unit 151 may use an algorithm to compensate for motion of the image.

A block matching algorithm is widely used in the DIS for detecting motion. The block matching algorithm uses the image signal itself, and various methods, such as a staged search method, have been proposed for reducing the amount of operations required for the motion compensation.

FIG. 2 is a diagram illustrating a method of estimating motion using vertical and horizontal projections.

As shown in FIG. 2, when estimating the motion of an image comprising n columns and m rows, average accumulation values with respect to a previous field (Kₜₕ) and a current field ((K+1)ₜₕ) are calculated.

At first, an average accumulation value is calculated along a horizontal direction. Each average accumulation value may be calculated by averaging values of pixels in a horizontal line. The method of finding the average accumulation value is well known and, thus, a detailed description will be omitted. H_{K} represents a value of a previous field along a horizontal direction, and H_{K+1} represents a value of a current field along a horizontal direction.

Then, an average accumulation value is calculated along a vertical direction. Each average accumulation value may be calculated by averaging values of pixels in a vertical line. V_{K} represents a value of a previous field along a vertical direction, and V_{K+1} represents a value of a current field along a vertical direction. VM represents a motion in a vertical direction, and HM represents a motion in a horizontal direction.

When the averaged accumulation values of each of the previous field and current field are calculated, a correlation between the two values is calculated. Thereafter, a motion vector is estimated based on a location having the highest correlation.

FIG. 3 is a block diagram illustrating a conventional DIS.

Referring to FIG. 3, the conventional DIS includes a vertical motion estimation unit 30, a vertical motion compensation vector calculation unit 31, a horizontal motion estimation unit 32, a horizontal motion compensation vector calculation unit 33, and an image compensation unit 34.

The vertical motion estimation unit 30 extracts a motion vector along the vertical direction of the picture (P) for estimating the motion. The vertical motion compensation vector calculation unit 31 calculates a motion compensation vector of the vertical direction using the motion vector provided by the vertical motion estimation unit 30. The horizontal motion estimation unit 32 extracts a motion vector along the horizontal direction of the picture (P) for estimating the motion. The horizontal motion compensation vector calculation unit 33 calculates a motion compensation vector of the horizontal direction using the motion vector provided by the horizontal motion estimation unit 32. The image compensation unit 34 compensates for camera shake using the motion compensation vectors provided by the vertical motion compensation vector calculation unit 31 and the horizontal motion compensation vector calculation unit 33.

An image size used to estimate motion is referred to as a DIS window. The DIS window of the conventional DIS corresponds to the whole picture. Thus, the vertical motion estimation unit 30 and the horizontal motion estimation unit 32 of the conventional DIS extract the motion vectors from the whole picture. The vertical motion compensation vector calculation unit 31 and the horizontal motion compensation vector calculation unit 33 calculate a motion compensation vector using the motion vectors. The image compensation unit 34 generates a control signal for adjusting an address of read image data stored in a field memory using the motion compensation vector and, thus, the image is stabilized.

FIG. 4 is a photograph illustrating a situation when a sudden shift effect occurs.

The DIS window of the conventional DIS is the whole picture. Therefore, in case that a large object moves in the picture, the DIS regards the moving object as camera shake, and compensates the image of the picture.

When the DIS compensates the image of the picture by regarding the motion of the large object as camera shake, the compensated picture is instantly panned along with the moving object. This phenomenon is referred to as the sudden shift effect.

Thus, image compensation capable of preventing the sudden shift effect is required.

### SUMMARY OF THE INVENTION

Accordingly, exemplary embodiments of the present invention are provided to substantially obviate one or more problems due to limitations and disadvantages of the related art.

Exemplary embodiments of the present invention provide an image stabilizer, an image system including the image stabilizer, and a method of stabilizing an image, capable of preventing a sudden shift effect.

In exemplary embodiments of the present invention, an image stabilizer includes a motion estimation unit, a motion vector selection unit, a motion compensation vector calculation unit and an image compensation unit. A plurality of divided areas of a picture is projected onto a respective plurality of windows. The motion estimation unit extracts motion vectors from the plurality of windows. The motion vector selection unit selects an optimal motion vector among the plurality of motion vectors. The motion compensation vector calculation unit calculates a motion compensation vector using the optimal motion vector. The image compensation unit compensates an image of the picture using the motion compensation vector.

In an exemplary embodiment, the motion vector selection unit may select the optimal motion vector having more than half of a total incidence rate among the plurality of motion vectors.

In an exemplary embodiment, the motion vector selection unit may select the optimal motion vector having a maximum incidence rate among the plurality of motion vectors.

The image stabilizer may further include a field memory configured to store an image signal of the picture, and the image signal may be inputted to the motion estimation unit. The image compensation unit may generate a control signal using the motion vector, and may change a read address of the image signal stored in the field memory according to the control signal.

The picture may be divided into m (column)×n (row) windows where n and m are natural numbers. The motion estimation unit includes a first motion estimator configured to extract m×n first motion vectors with respect to a first direction and a second motion estimator configured to extract m×n second motion vectors with respect to a second direction.

The motion vector selection unit may include a first selection unit configured to select a first optimal motion vector among the m×n first motion vectors and a second selection unit configured to select a second optimal motion vector among the m×n second motion vectors.

The motion compensation vector calculation unit may include a first motion compensation vector calculation unit configured to calculate a first motion compensation vector using the first optimal motion vector and a second motion compensation vector calculation unit configured to calculate a second motion compensation vector using the second optimal motion vector.

In exemplary embodiments of the present invention, an image system includes an optical sensing device, a digital signal process unit (DSP), and a motion estimation/compensation unit. The optical sensing device may receive an optical scene and output an image signal. The image signal is an electric signal converted from the optical scene. The DSP may receive and digitally process the image signal. The motion estimation/compensation unit may divide a picture into a plurality of areas using the digitally processed image signal, may estimate motion vectors of the plurality of divided areas, select an optimal motion vector among the motion vectors, may calculate a motion compensation vector using the optimal motion vector, and may compensate the image signal using the motion compensation vector.

The motion estimation/compensation unit may include a motion estimation unit, a motion vector selection unit, a motion vector calculation unit, and an image compensation unit. The plurality of divided areas of the picture is projected onto a respective plurality of windows. The motion estimation unit may extract the motion vectors from the plurality of windows. The motion vector selection unit may select the optimal motion vector among the plurality of motion vectors. The motion vector calculation unit may calculate the motion compensation vector using the optimal motion vector. The image compensation unit may compensate an image of the picture using the motion compensation vector.

In an exemplary embodiment, the motion vector selection unit may select the optimal motion vector having more than half of a total incidence rate among the plurality of motion vectors.

In exemplary embodiments, the motion vector selection unit may select the optimal motion vector having a maximum incidence rate from among the plurality of motion vectors.

The image system may further include a field memory configured to store an image signal of the picture, and the image signal may be inputted to the motion estimation unit. The image compensation unit may generate a control signal using the motion vector, and may change a read address of the image signal stored in the field memory according to the control signal.

The picture may be divided into m (column)×n (row) windows where n and m are natural numbers. The motion estimation unit may include a first motion estimator configured to extract m×n first motion vectors with respect to a first direction and a second motion estimator configured to extract m×n second motion vectors with respect to a second direction.

The motion vector selection unit may include a first selection unit configured to select a first optimal motion vector among the m×n first motion vectors and a second selection unit configured to select a second optimal vector among the m×n second motion vectors.

The motion compensation vector calculation unit may include a first motion compensation vector calculation unit configured to calculate a first motion compensation vector from the first motion vector and a second motion compensation vector calculation unit configured to calculate a second motion compensation vector from the second motion vector.

The image system may further include a display device configured to display a motion-compensated picture using the motion-compensated image signal.

In exemplary embodiments of the present invention, a method of stabilizing an image includes dividing a picture into a plurality of areas, forming a plurality of windows projected from the plurality of the divided areas, extracting motion vectors of the plurality of the projected windows, selecting an optimal motion vector among the motion vectors, calculating a motion compensation vector using the selected optimal motion vector, and compensating an image of the picture using the motion compensation vector.

In an exemplary embodiment, selecting the optimal motion vector may include selecting the optimal motion vector having more than half of a total incidence rate among the plurality of motion vectors.

In an exemplary embodiment, selecting the optimal motion vector may include selecting the optimal motion vector having a maximum incidence rate among the plurality of motion vectors.

Therefore, the image stabilizer according to an exemplary embodiment of the present invention may provide a high quality image signal by reducing a sudden shift effect when stabilizing the image.

### BRIEF DESCRIPTION OF THE DRAWINGS

Exemplary embodiments of the present invention will be understood in detail from the following descriptions taken in conjunction with the attached drawings.

FIG. 1 is a block diagram illustrating a conventional camera device.

FIG. 2 is a diagram illustrating a method of estimating motion using vertical and horizontal projections.

FIG. 3 is a block diagram illustrating a conventional digital image stabilizer (DIS).

FIG. 4 is a photograph illustrating an image stabilizer according to an exemplary embodiment of the present invention.

FIG. 6 is a block diagram illustrating an image stabilizer having sixteen DIS windows according to an exemplary embodiment of the present invention.

FIG. 7 is a flow chart illustrating a method of stabilizing an image according to an exemplary embodiment of the present invention.

FIG. 8 is a block diagram illustrating an image system including the image stabilizer according to an exemplary embodiment of the present invention.

FIG. 9 is a block diagram illustrating an image system including the image stabilizer according to an exemplary embodiment of the present invention.

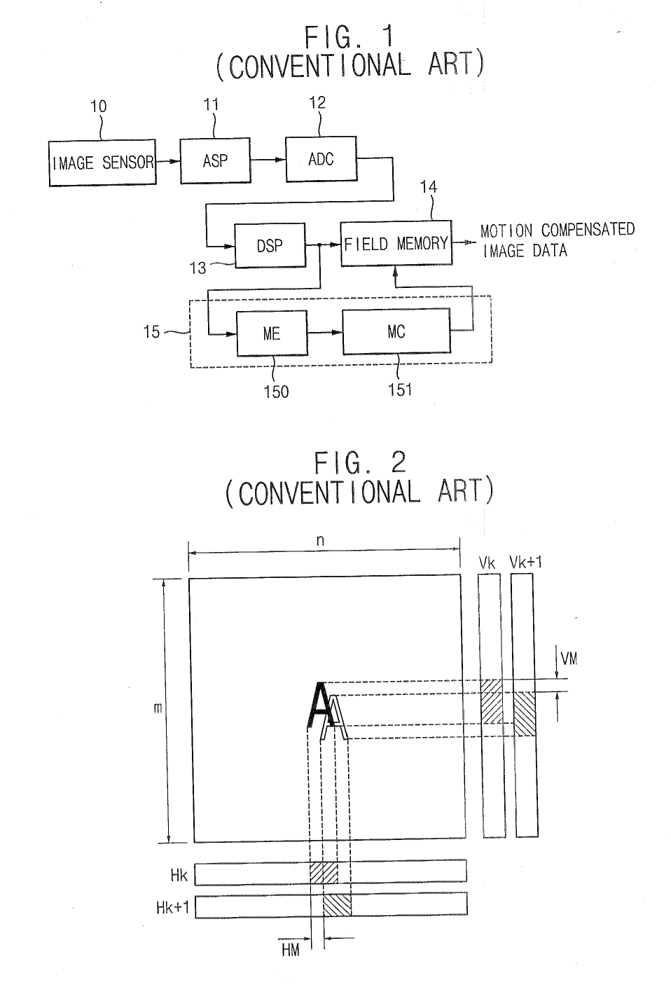

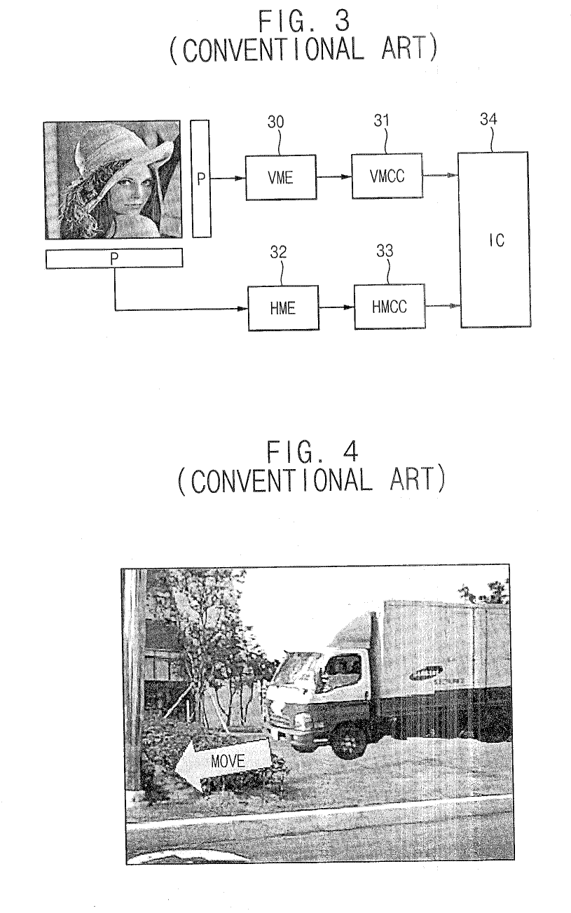

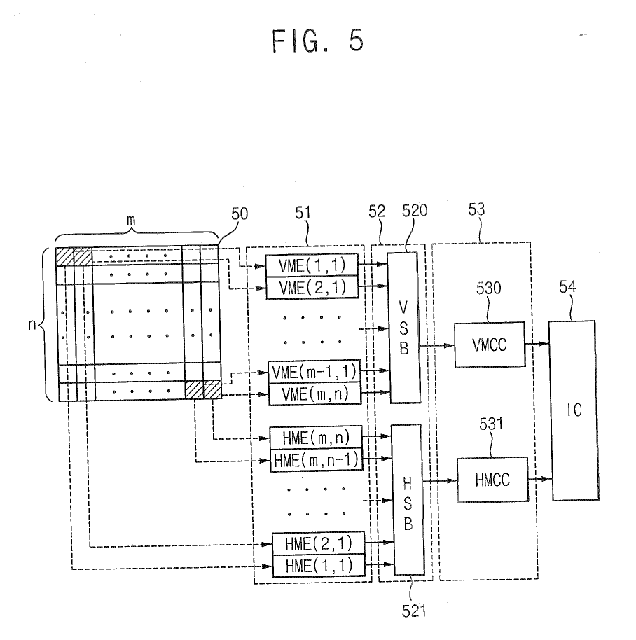

### DESCRIPTION OF EXEMPLARY EMBODIMENTS

The present invention now will be described more fully with reference to the accompanying drawings, in which exemplary embodiments of the present invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. Like reference numerals refer to like elements throughout this application.

FIG. 5 is a block diagram illustrating an image stabilizer according to an exemplary embodiment of the present invention.

Referring to FIG. 5, the image stabilizer includes a motion estimation unit 51, a motion vector selection unit 52, a motion compensation vector calculation unit 53 and an image compensation unit 54.

The motion estimation unit 51 extracts a plurality of vertical motion vectors and a plurality of horizontal motion vectors from digital image stabilizer (DIS) windows corresponding to divided (or partitioned) areas of a picture 50 detected by an image sensor (not shown). The motion vector selection unit 52 selects optimal vertical and horizontal motion vectors among the vertical and horizontal motion vectors provided by the motion estimation unit 51. The motion compensation vector calculation unit 53 calculates vertical and horizontal motion compensation vectors using the optimal vertical and horizontal motion vector provided by the motion vector selection unit 52. The image compensation unit 54 compensates for camera shake using the motion compensation vector provided by the motion compensation vector calculation unit 53.

The motion estimation unit 51 may include several motion estimation blocks VME_{(1,1)} to VME_{(m,n)}, HME_{(1,1)} to HME_{(m,n)} for estimating motion by extracting vertical and horizontal motion vectors and, thus, the number of motion estimation blocks VME_{(1,1)} to VME_{(m,n)}, HME_{(1,1)} to HME_{(m,n)} may correspond to the number of divided areas.

The motion vector selection unit 52 may include a vertical selection block 520 for selecting an optimal vertical motion vector and a horizontal selection block 521 for selecting an optimal horizontal motion vector.

The motion compensation vector calculation unit 53 may include a vertical motion compensation vector calculation block 530 for calculating a vertical compensation vector from the optimal vertical motion vector and a horizontal motion compensation vector calculation block 531 for calculating a horizontal motion compensation vector from the optimal horizontal vector.

As described above, in the conventional motion compensation systems, a sudden shift effect occurs due to a panning effect when a large object moves in a picture, because motion vectors are extracted from the whole picture. The image stabilizer according to an exemplary embodiment of the present invention, however, divides the whole picture into a plurality of areas, extracts the motion vectors of the divided areas, respectively, and determines the optimal motion vector of the picture. For example, the motion vector selection unit 520 may select a motion vector having more than half of a total incidence rate or a motion vector having a maximum incidence rate from among the plurality of motion vectors as the optimal motion vector.

The image stabilizer according to an exemplary embodiment of the present invention extracts the motion vectors from the divided areas to compensate for camera shake.

The m×n vertical motion estimation blocks and the m×n horizontal motion estimation blocks are required when the whole picture is divided into m columns and n rows.

The motion vector selection unit 52 selects the optimal motion vector from among the motion vectors provided by the motion estimation unit 51.

According to an exemplary embodiment of the present invention, the motion vector selection unit may select the optimal motion vector having more than half of the total incidence rate from among the motion vectors. When the motion vector having more than half of the total incidence rate does not exist, the motion vector selection unit may select the optimal motion vector having a maximum incidence rate from among the motion vectors.

An incidence rate refers to how many motion vectors have the same value in the plurality of motion vectors extracted from the divided areas of the one picture. For example, when three motion vectors among the total motion vectors have the same value, the incidence rate of those three vectors would correspond to three. In other words, the higher the incidence rate the motion vector has, the more motion vectors have the same value.

The optimal motion may be selected using vertical and horizontal components of the motion vectors. Thereafter, the motion vector selection unit selects the optimal motion vector representing the optimal motion from among the plurality of motion vectors.

In exemplary embodiments, vertical and horizontal motion vectors of the plurality of areas are divided into groups based on the correlations of the motion vectors. Then, a group having more than half of the total incidence rate is selected. A motion vector having a maximum incidence rate in the selected group may be selected as the optimal motion vector. For example, it is assumed that incidence rates of the motion vectors a1, a2 and b are 2.5, 3.5, and 4 respectively, and that a1 and a2 are highly correlated. In this example, the motion vectors are divided into two groups. The first group includes a1 and a2, and the second group includes b. The first group is selected for determining the optimal motion vector, because the sum of the incidence rates of the first group is more than half of the total incidence rate. Then, a2 of the first group is selected as the optimal motion vector, because the incidence rate of a2 is higher than the incidence rate of a1.

As described above, the optimal motion vector may be selected merely according to the incidence rate. In the above case, b may be the optimal vector, because b has the highest incidence rate among the three motion vectors.

In the motion compensation vector calculation unit 53, the vertical motion compensation vector calculation block 530 and the horizontal motion compensation vector calculation block 531 calculate the motion compensation vector using the optimal motion vectors. The image compensation unit 54 generates a control signal based on the motion compensation vector for changing an address used to read image data stored in a field memory and, thus, the image stabilization is accomplished.

Hereinafter, extracting the motion vectors and extracting the optimal motion vector with respect to more detailed situations will be described.

Initially, a case in which the picture includes no large moving object and the picture is blurred due to camera shake is considered.

In the case where the picture is blurred due to camera shake, all the motion vectors of the DIS windows, that is, the divided areas of the picture, will have the same value because the image of the whole picture moves in the same direction.

An error of the motion vectors extracted from the divided DIS windows may be larger than an error of the motion vector extracted from the whole picture. Thus, the error term may be included in the motion vectors extracted from the DIS windows. The individual motion vectors of the DIS windows may include error terms, but the motion vectors will be highly correlated since the motion vectors all have substantially the same direction.

Secondly, the case in which the picture has a large moving object and camera shake is relatively smaller than the movement of the object is considered.

Motion vectors of some divided DIS windows including parts of the large moving object may have values close to those of a movement of the object that is not due to camera shake. Most of the DIS windows, however, do not include the moving object and will have a value according to camera shake.

Therefore, the optimal motion vector is selected using the plurality of motion vectors extracted from the divided DIS windows.

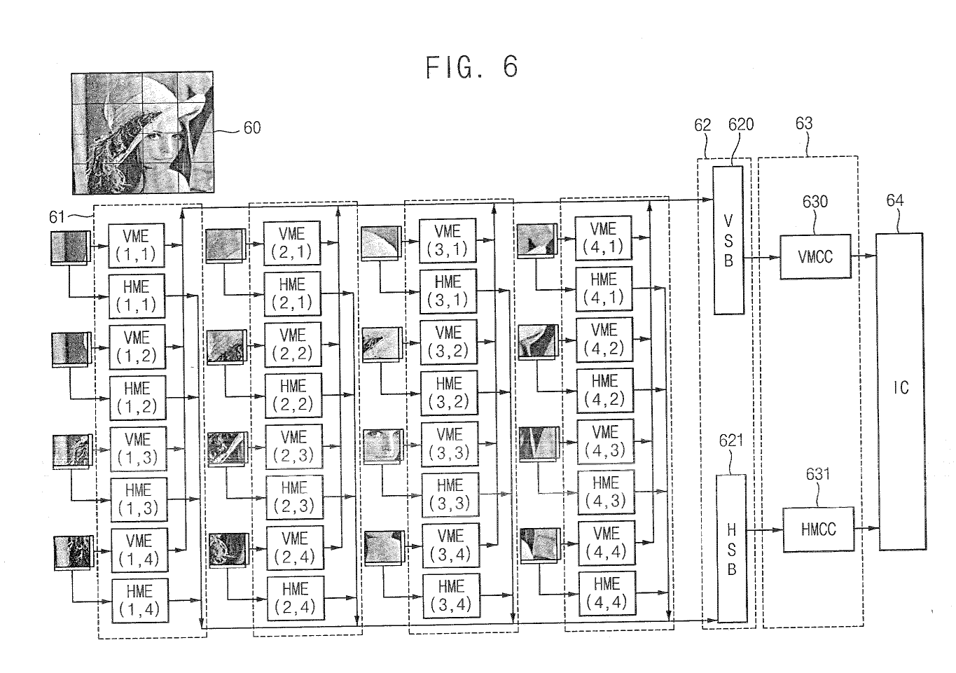

FIG. 6 is a block diagram illustrating an image stabilizer having sixteen DIS windows according to an exemplary embodiment of the present invention.

Referring to FIG. 6, the image stabilizer having sixteen DIS windows includes a motion estimation unit 61, a motion vector selection unit 62, a motion compensation vector calculation unit 63 and an image compensation unit 64. An entire picture 60 may be divided (or partitioned) into the sixteen divided areas.

The motion estimation unit 61 extracts sixteen vertical motion vectors and sixteen horizontal motion vectors from sixteen DIS windows. The motion vector selection unit 62 selects optimal vertical and horizontal motion vectors among the sixteen vertical motion vectors and sixteen horizontal motion vectors provided by the motion estimation unit 61. The motion compensation vector calculation unit 63 calculates vertical and horizontal motion compensation vectors using the optimal vertical and horizontal vectors provided by the motion vector selection unit 62. The image compensation unit 64 compensates for a blurry image due to camera shake using the motion compensation vector provided by the motion compensation vector calculation unit 63.

The motion estimation unit 61 may include sixteen vertical motion estimation blocks and sixteen horizontal motion estimation blocks for extracting motion vectors from the divided DIS windows. The number of vertical estimation blocks and horizontal estimation blocks included in the motion estimation unit 61, however, may be modified. In case that the motion estimation unit 61 includes eight vertical motion estimation blocks and eight horizontal motion estimation blocks, the eight vertical motion estimation blocks extract eight vertical motion vectors and the eight horizontal motion estimation blocks extract eight horizontal motion vectors from the eight divided DIS windows. In case that the motion estimation unit 61 includes four vertical motion estimation blocks and four horizontal motion estimation blocks, the four vertical motion estimation blocks extract four vertical motion vectors and the four horizontal motion estimation blocks extract four horizontal motion vectors from the four divided DIS windows.

The motion vector selection unit 62 may include a vertical motion vector selection block 620 and a horizontal motion vector selection block 621.

The motion compensation vector calculation unit 63 may include a vertical motion compensation vector calculation block 630 for calculating a vertical motion compensation vector using the optimal vertical vector selected by the motion vector selection unit 62 and a horizontal motion compensation vector calculation block 631 for calculating a horizontal motion compensation vector using the optimal horizontal vector selected by the motion vector selection unit 62.

As shown in FIG. 6, the image stabilizer of this exemplary embodiment divides the whole picture into sixteen areas, and uses each of the divided areas as DIS windows. The image stabilizer extracts the motion vectors from the divided DIS windows. The motion vector having a maximum incidence rate may be selected as the optimal motion vector. On the other hand, a group having more than half of the total incidence rate may selected, and then a motion vector having a maximum incidence rate in the selected group may be selected as the optimal motion vector.

The motion vector selection unit 62 selects the optimal vertical motion vector and the optimal horizontal motion vector among the vertical and horizontal motion vectors provided by the motion estimation unit 61.

In the motion compensation vector calculation unit 63, the vertical motion compensation vector calculation block 630 and the horizontal motion compensation vector calculation block 631 calculate the motion compensation vector using the optimal motion vectors. The image compensation unit 64 generates a control signal based on the motion compensation vector for changing an address to read image data stored in a field memory and, thus, image stabilization is accomplished.

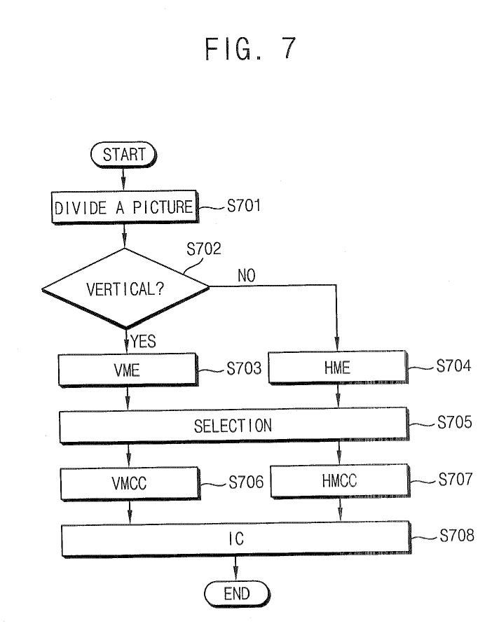

FIG. 7 is a flow chart illustrating a method of stabilizing an image according to an exemplary embodiment of the present invention.

Referring to FIG. 7, a digital image signal, which has been processed by a device such as a digital signal processor (DSP), is provided. For example, the digital-signal-processing may include converting an original image signal of RGB format to a digital signal, interpolating and compensating the digital signal, converting the compensated digital signal of RGB format to YCbCr format, and suppressing the color of the digital signal. The color-suppressed digital signal of YCbCr format is the digital-signal-processed image signal. The image signal is provided frame units, and one picture (image) may consist of one frame. Each picture is divided into a plurality of areas, and the plurality of divided areas is projected onto a plurality of DIS windows (step S701).

Each of the projected DIS windows is determined to be either a vertical component or a horizontal component (step S702). Vertical motion vectors according to each of the projected DIS windows designated as vertical components are estimated (step S703). Horizontal motion vectors according to each of the projected DIS windows designated as horizontal components are estimated (step S704).

An optimal horizontal motion vector and an optimal vertical motion vector are selected based on the incidence rate (step S705).

A vertical motion compensation vector is calculated using the optimal vertical motion vector (step S706), and a horizontal motion vector compensation is calculated using the optimal horizontal motion vector (step S707).

Blurriness of the image due to camera shake is compensated for using the vertical motion compensation vector and the horizontal motion compensation vector (step S708).

An image system including the image stabilizer is described hereinafter.

FIG. 8 is a block diagram illustrating an exemplary embodiment of an image system including the image stabilizer according to an exemplary embodiment of the present invention. The image stabilizer may be implemented as illustrated in FIGS. 5 and 6.

Referring to FIG. 8, the image system includes an optical sensing device 80, an ADC 84, a line memory 85, a DSP 81, a field memory 86, a motion estimation/compensation unit 83 and a display device 82. The optical sensing device 80 receives an optical image and outputs an electrical signal converted from the optical image. The ADC 84 converts an output signal of the optical sensing device 80 to a digital signal when the output signal of the optical sensing device 80 is an analog signal. The ADC 84 is not needed when the output of the optical sensing device 80 is a digital signal. The line memory 85 has a capacity for storing a plurality of lines of an image signal converted to a digital signal. The DSP 81 receives the digital image signal provided by the line memory 85, performs image and gamma correction, and converts the digital image signal to YCbCr format. The field memory 86 stores an output signal of the DSP 81. The motion estimation/compensation unit 83 divides a picture into a plurality of areas using the digitally processed image signal, estimates motion vectors of the plurality of divided areas, selects an optimal vector among the motion vectors, calculates a motion compensation vector using the optimal vector, and compensates the image signal using the motion compensation vector. The display device 82 displays the motion-compensated image signal.

The field memory 86 stores the image data outputted from the DSP 81, and outputs image data compensated by an address control signal of the motion estimation/compensation unit 83.

The motion estimation/compensation unit 83 may include a motion estimation unit 830 for detecting camera shake using the image data provided by the DSP 81 and a motion compensation unit 831 for generating the signal to control an address of the field memory 86. The control signal outputted from the motion compensation unit 86 is provided to the field memory 86, whereby the motion-compensated image data is outputted from the field memory 86 to the display device 82.

The image stabilizer essentially comprises the field memory 86 and the motion estimation/compensation unit 83 including the motion estimation unit 830 and the motion compensation unit 831.

An analog signal processor (not shown) for processing (amplifying) an analog signal, which is an electrical signal outputted from the optical sensing device 80, may be further included between the optical sensing device 80 and the ADC 84.

The optical sensing device 80 may use various types of sensors such as a charge-coupled device (CCD) or a complementary metal-oxide semiconductor (CMOS) image sensor (CIS).

When the ADC is contained inside the optical sensing device 80 or the DSP 81, the ADC 84 in FIG. 8 may be omitted.

The line memory 85 also may be contained inside the optical sensing device 80 or the DSP 81.

The display device 82 may include a display unit and a driving unit, and may use a liquid crystal display (LCD) or a plasma display panel (PDP).

The image system without the display device 82 in FIG. 8 may also be applied, for example, to a camera device.

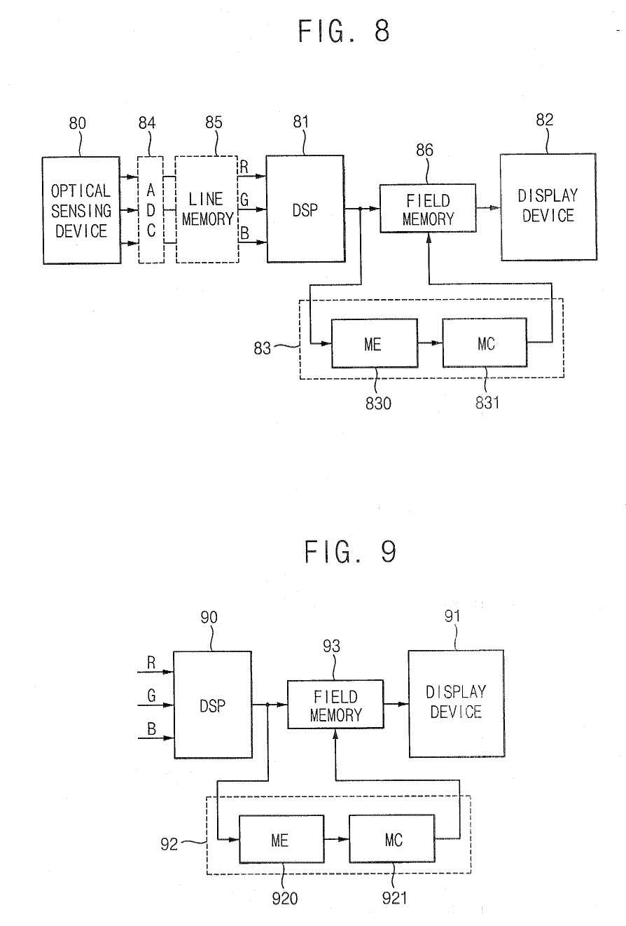

FIG. 9 is a block diagram illustrating an image system including the image stabilizer according to an exemplary embodiment of the present invention. The image stabilizer may be implemented as illustrated in FIGS. 5 and 6.

Referring to FIG. 9, the image system according to an exemplary embodiment of the present invention includes a DSP 90, a field memory 93, a motion estimation/compensation unit 92 and a display device 91. The DSP 90 receives a digital image signal in RGB format, performs image and gamma correction, and converts the digital image signal to a signal of YCbCr format. The motion estimation/compensation unit 92 divides a picture into a plurality of areas using the digitally processed image signal, estimates motion vectors of the plurality of divided areas, selects an optimal vector among the motion vectors, calculates a motion compensation vector using the optimal vector, and compensates the image signal using the motion compensation vector. The display device 91 displays the motion-compensated image signal.

An ADC (not shown) or a line memory (not shown) may be included in front of the DSP 90. A detailed description of a similar configuration to that of FIG. 8 is omitted.

Exemplary embodiments of the present invention divide a picture into a plurality of areas, estimate vertical and horizontal motion vectors according to divided areas instead of estimating one representative motion vector from the entire picture, select an optimal vector among the motion vectors, calculate a motion compensation vector using the optimal vector, and compensate the image signal using the motion compensation vector. Thereby, a sudden shift effect caused by a large moving object in the picture may be reduced.

In exemplary embodiments of the present invention described above, a high quality image signal may be provided by reducing the sudden shift effect when stabilizing the image.

While the exemplary embodiments of the present invention and their advantages have been described in detail, it should be understood that various changes, substitutions and alterations may be made herein without departing from the scope of the invention.

What is claimed is:

1. An image stabilizer comprising:
a motion estimation unit configured to extract motion vectors from a plurality of windows, the plurality of windows being projected from a plurality of divided areas of a picture;
a motion vector selection unit configured to select a motion vector from among the plurality of motion vectors;
a motion compensation vector calculation unit configured to calculate a motion compensation vector using the selected motion vector; and
an image compensation unit configured to compensate an image of the picture using the calculated motion compensation vector.

2. The image stabilizer of claim 1, wherein the motion vector selection unit selects the motion vector having more than half of a total incidence rate from among the plurality of motion vectors.

3. The image stabilizer of claim 1, wherein the motion vector selection unit selects the motion vector having a maximum incidence rate from among the plurality of motion vectors.

4. The image stabilizer of claim 1, further comprising:
a field memory configured to store an image signal of the picture, the image signal being inputted to the motion estimation unit,
wherein the image compensation unit generates a control signal using the motion vector, and changes a read address of the image signal stored in the field memory according to the control signal.

5. The image stabilizer of claim 1, wherein the picture is divided into m (column)×n (row) windows, n and m being natural numbers, and
wherein the motion estimation unit comprises:
a first motion estimator configured to extract m×n first motion vectors with respect to a first direction; and
a second motion estimator configured to extract m×n second motion vectors with respect to a second direction.

6. The image stabilizer of claim 5, wherein the motion vector selection unit comprises:
a first selection unit configured to select a first motion vector from among the m×n first motion vectors; and
a second selection unit configured to select a second motion vector from among the m×n second motion vectors.

7. The image stabilizer of claim 6, wherein the motion compensation vector calculation unit comprises:
a first motion compensation vector calculation unit configured to calculate a first motion compensation vector using the first motion vector; and
a second motion compensation vector calculation unit configured to calculate a second motion compensation vector using the second motion vector.

8. An image system comprising:
an optical sensing device configured to receive an optical scene and output an image signal, the image signal being an electrical signal corresponding to the optical scene;
a digital signal processor unit (DSP) configured to receive an digitally process the image signal; and
a motion estimation/compensation unit configured to divide a picture of the scene into a plurality of areas using the digitally processed image signal, configured to estimate respective motion vectors of the plurality of divided areas, configured to select a motion vector from among the motion vectors, configured to calculate a motion compensation vector using the selected motion vector, and configured to compensate the image signal using the calculated motion compensation vector.

9. The image system of claim 8, wherein the motion estimation/compensation unit comprises:
a motion estimation unit configured to extract the respective motion vectors from a plurality of windows, the plurality of windows being projected from the plurality of divided areas of the picture;
a motion vector selection unit configured to select the motion vector from among the plurality of motion vectors;
a motion vector calculation unit configured to calculate the motion compensation vector using the selected motion vector; and
an image compensation unit configured to compensate an image of the picture using the calculated motion compensation vector.

10. The image system of claim 9, wherein the motion vector selection unit selects the motion vector having more than half of a total incidence rate among the plurality of motion vectors.

11. The image system of claim 9, wherein the motion vector selection unit selects the motion vector having a maximum incidence rate among the plurality of motion vectors.

12. The image system of claim 9, further comprising:
a field memory configured to store an image signal of the picture, the image signal being inputted to the motion estimation unit,
wherein the image compensation unit generates a control signal using the selected motion vector, and changes a read address of the image signal stored in the field memory according to the control signal.

13. The image system of claim 9, wherein the picture is divided into m (column)×n (row) windows, n and m being natural numbers, and
wherein the motion estimation unit comprises:
a first motion estimator configured to extract m×n first motion vectors with respect to a first direction; and
a second motion estimator configured to extract m×n second motion vectors with respect to a second direction.

14. The image system of claim 13, wherein the motion vector selection unit comprises:
a first selection unit configured to select a first motion vector among the m×n first motion vectors; and
a second selection unit configured to select a second motion vector among the m×n second motion vectors.

15. The image system of claim 14, wherein the motion compensation vector calculation unit comprises:
a first motion compensation vector calculation unit configured to calculate a first motion compensation vector using the first motion vector; and
a second motion compensation vector calculation unit configured to calculate a second motion compensation vector using the second motion vector.

16. The image system of claim 9, further comprising a display device configured to display the compensated picture using the motion-compensated image signal.

17. A method of stabilizing an image comprising:
dividing a picture into a plurality of areas;
forming a plurality of windows projected from the plurality of areas;
extracting a plurality of motion vectors from the plurality of windows;
selecting a motion vector among the extracted plurality of motion vectors;
calculating a motion compensation vector using the selected motion vector; and
compensating an image of the picture using the calculated motion compensation vector.

18. The method of claim 17, wherein selecting the motion vector comprises selecting the motion vector having more than half of a total incidence rate from among the plurality of motion vectors.

19. The method of claim 17, wherein selecting the optimal motion vector comprises selecting the motion vector having a maximum incidence rate from among the plurality of motion vectors.
